(19) United States
(12) Patent Application Publication
(10) Pub. No.: US 2012/0299296 A1
(43) Pub. Date: Nov. 29, 2012

(54) Compression Connector for Flexible Tubing

(75) Inventor: Francis J. Lombardi, III, Erie, CO (US)

(73) Assignee: Nordson Corporation, Westlake, OH (US)

(21) Appl. No.: 13/480,290

(22) Filed: May 24, 2012

Related U.S. Application Data
(60) Provisional application No. 61/489,671, filed on May 24, 2011.

(51) Int. Cl. F16L 25/04

(52) U.S. Cl. 285/389

(57) ABSTRACT

A compression connector for flexible tubing has a clamp fitting and a compression collar that securely fastens to the clamp fitting. The clamp fitting has an inner sleeve defining a lumen and an outer tapered sealing surface, grip fingers, and male thread. The compression collar has female thread for mating with the male thread of the clamp fitting and a conical surface for mating with the grip fingers and clamping them against the fluid tubing inserted into the compression connector. The grip fingers retain tubing sealed against the tapered surface of the sleeve without impeding fluid flow. Elimination of the barb on the outer diameter of a connector for fluid tubing eliminates the potential for trapped fluid. The inner diameter of the inner sleeve is substantially the same as the inner diameter of the fluid tubing in order to reduce turbidity in fluid flow through the system.

### CROSS REFERENCE TO RELATED APPLICATIONS

This application claims the benefit of priority pursuant to 35 U.S.C. §119(e) of U.S. provisional application No. 61/489,671 filed 24 May 2011 entitled “Compression connector for flexible tubing,” which is hereby incorporated herein by reference in its entirety.

### TECHNICAL FIELD

The technology described herein relates to connectors for flexible tubing and, in particular, compression fit connectors for flexible tubing.

### BACKGROUND

Traditional barb connectors 102 for flexible tubing as shown in prior art FIG. 1 create a friction fit between an annular barb 108 protruding from an outer diameter surface of the barb connector 102 and an end of a length of flexible fluid tubing 104. The barb 108 distorts the wall of the fluid tubing 104, which stretches radially to advance over the barb 108 on the connector 102. The section of the fluid tubing 104 that extends distally beyond the barb 108 then contracts to conform to the outer diameter of the barb connector 102. While the diameter of the barb 108 is larger than the inner diameter 114 of the fluid tubing to create a tight friction fit, the outer diameter 116 of the neck of the connector 102 is typically the same as the inner diameter 114 of the fluid tubing 104. This means that the inner diameter 112 forming the lumen of the barb connector 102 is typically smaller than the inner diameter of the tubing 104.

In this configuration, the stretching of the fluid tubing 104 over the barb 108 inherently creates a small void area 110 on the back edge of the barb that can trap fluid near the neck of the connector 102 as shown in prior art FIG. 2. This trapped fluid has the potential to leach into the fluid stream passing through the tubing and the connector 102 over time. This is caused by the tubing 104 expanding or ballooning when fluid pressure is applied to the system, which allows fluid to pass over the barb 108 and enter this void area 110. Once the pressure is reduced the fluid is trapped in the void area 110. When pressure is once again applied, the fluid previously trapped in the void space 110 is allowed to enter back into the system. This can potentially cause contamination, which may be undesirable, especially with respect to the bio-pharmaceutical and food processing industries.

The information included in this Background section of the specification, including any references cited herein and any description or discussion thereof, is included for technical reference purposes only and is not to be regarded subject matter by which the scope of the invention as defined in the claims is to be bound.

### SUMMARY

Elimination of the barb on the outer diameter of a connector for fluid tubing would eliminate the potential for trapped fluid. It is also desirable to increase the inner diameter of a connector to be closer to or the same as the inner diameter of the tubing being used in order to reduce turbidity in fluid flow through the system. A compression connector for flexible tubing as disclosed herein may be composed of two components: a clamp fitting and a compression collar that securely fastens to the clamp fitting. The clamp fitting has an inner sleeve defining a lumen and an outer tapered sealing surface, grip fingers, and male thread. The compression collar has female thread for mating with the male thread of the clamp fitting and a conical surface for mating with the grip fingers and clamping them against the fluid tubing inserted into the compression connector. The grip fingers help retain tubing sealed against the tapered surface of the sleeve without impeding flow with a reduced inner diameter, unlike typical barbed fittings.

In an exemplary implementation, a compression connector for flexible fluid tubing may have a clamp fitting and a compression collar. The clamp fitting may be composed of an inner sleeve, a plurality of grip fingers, and a base defining a male thread. The inner sleeve may define a lumen and have an outer sealing surface configured to fit within an end of a flexible fluid tubing. The plurality of grip fingers may be positioned circumferentially about and apart from the inner sleeve and configured to deflect radially inward toward the outer sealing surface of the inner sleeve. The compression collar may securely fasten to the clamp fitting and have an internal female thread for mating with the male thread of the clamp fitting. The compression collar may also have an inner surface for mating with the plurality of grip fingers and deflecting the plurality of grip fingers to engage and retain a flexible fluid tubing placed on the outer sealing surface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1A is an isometric view of a prior art barb connector connected to a length of flexible fluid tubing.

FIG. 1B is an elevation view in cross section of the prior art barb connector of FIG. 1A connected to a length of flexible fluid tubing.

FIG. 2 is an elevation view in cross section of a compression connector including a clamp fitting and a compression collar presently disclosed herein.

FIG. 3 is an elevation view in cross section of the clamp fitting and compression collar of FIG. 3 with a length of flexible fluid tubing inserted within the compression collar.

FIG. 4 is an elevation view in cross section of the clamp fitting and compression collar of FIG. 3 with a length of flexible fluid tubing inserted within the compression collar and about a sleeve of the clamp fitting.

FIG. 5 is an elevation view in cross section of the clamp fitting and compression collar of FIG. 3 with a length of flexible fluid tubing inserted within the compression collar and about a sleeve of the clamp fitting with the compression collar securely fastened to the clamp fitting.

FIG. 6 is an isometric view of the clamp fitting (not visible) fastened within the compression collar to connect the length of flexible fluid tubing.

### DETAILED DESCRIPTION

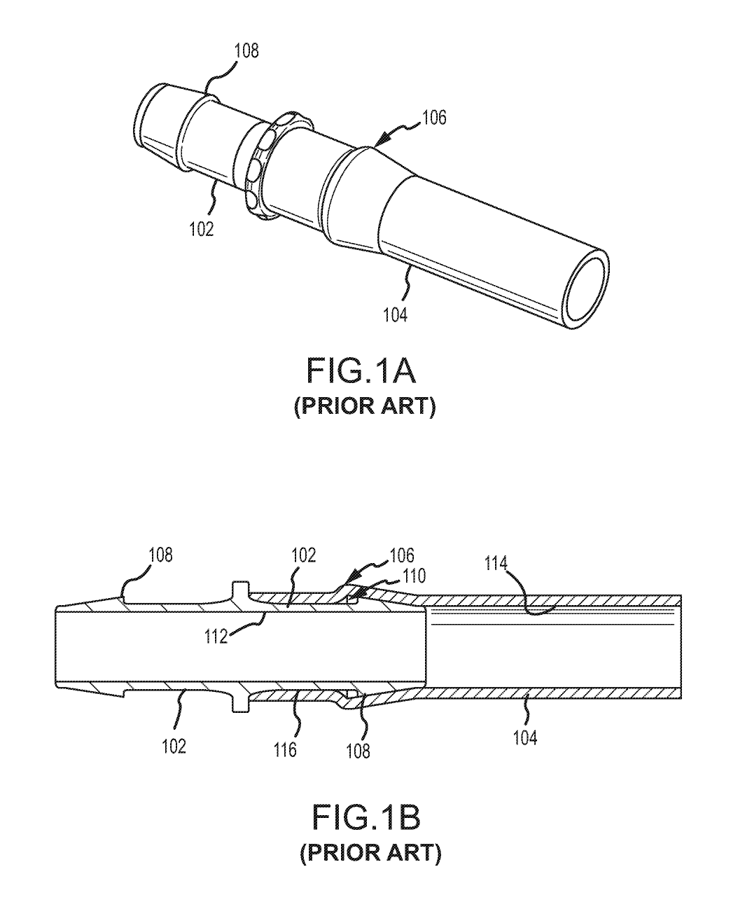

One end or half of a compression connector 200 is shown in FIG. 1 that includes a clamp fitting 202 and a compression collar 204. The proximal end of the clamp fitting 202 may further be formed as a reciprocal clamp fitting, as a barb connector fitting 102 (as exemplary shown in dashed lines), as a flat flange for adhering or welding to a flat connection surface, or as any other form of connector. In an exemplary implementation, the clamp fitting 202 and the compression collar 204 may be formed of plastic, for example, by injection molding. However, the clamp fitting 202 and the compression collar 204 may be formed of other materials and by other processes that would result in the same structural features and meet the same functional requirements as disclosed herein.

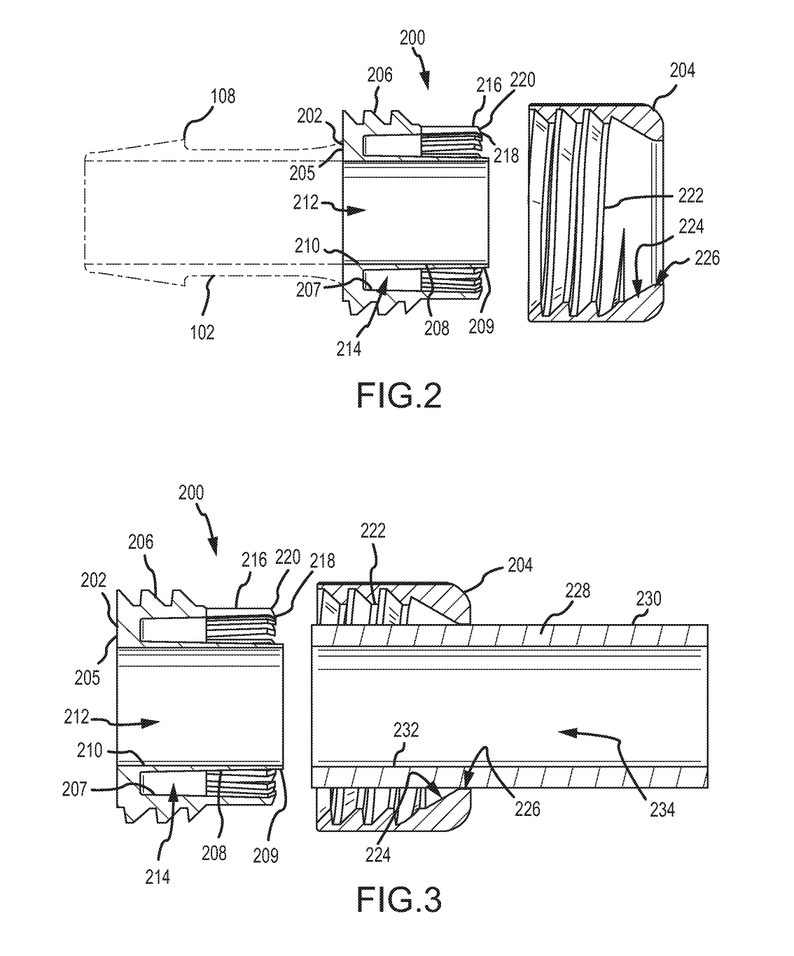

The clamp fitting 202 defines a male thread 206 about an outer diameter (OD) of the proximal end thereof. A sleeve 208 extends distally from the proximal end of the clamp fitting 202 and defines a lumen 212 for fluid flow through the connector. An OD 209 of the sleeve 208 is less than the inner diameter (ID) of a sidewall 207 in which the male threads 206 are formed. In this way, an annular well or channel 214 is formed between the sleeve 208, the sidewall 207, and an end wall 205 of the clamp fitting 202. As shown in FIG. 2, the sidewall 207 extends distally from the end wall 205 about half the length of the sleeve 208. In some embodiments, the ID 210 of the sleeve 208 defines a cylindrical lumen 212 within the sleeve 208. In other embodiments, the ID 210 of the sleeve 208 may define a tapered lumen within the sleeve 208 that creates a slight frustum form of the sleeve 208 in which the ID at the end wall 205 is slightly larger than the ID at the opposite end of the sleeve 208. As shown, the OD 209 of the sleeve 208 may decrease in size slightly from the proximal end to the distal end of the clamp fitting 202 to form a slight frustum form or tapered outer surface of the sleeve 208. This results in the annular channel 214 being formed with a narrower well bottom that aids in removal of an injection mold form.

A plurality of grip fingers 216 are formed on a distal edge of the sidewall 207 after the termination of the male thread section 206. The grip fingers 216 extend normally from the distal edge of the sidewall 207 in a cantilevered fashion, generally parallel to the sleeve 208. The grip fingers 216 may be uniformly separated about the circumference of the distal edge of the sidewall 207. The finger grips 216 taper in width slightly as they extend distally such that an angle of the inner surfaces of the finger grips 216 diverges from the tapered outer surface of the sleeve 208. At the distal end of each of the grip fingers 216, a chamfered bearing edge 220 is formed. The bearing edge 220 extends angularly inward toward the sleeve 208, extending past the inner surface of the respective grip finger 216 to terminate in a claw tip 218 that extends toward the sleeve 208.

The compression collar 204 is also depicted in FIG. 2. An inner wall of the compression collar 204 defines a female thread 222 that is sized to engage the male thread 206 of the clamp fitting 202 when the compression collar 204 and clamp fitting 202 are coupled together to form the compression connector 200. The proximal end of the compression collar 204 defines a collar rim 226 of a reduced diameter compared to the inner wall defining the female thread 222. An aperture defined by the collar rim 226 may be sized to snugly fit around the OD of a length of fluid tubing inserted within the compression collar 204. A conical surface 224 is formed on the inner wall of the compression collar 204 between the female thread 222 and the collar rim 226. The conical surface 224 may be formed as a chamfer of 45 degrees or other acute angle. The conical surface 224 interfaces with the bearing edges 220 of the grip fingers 216 to drive the claw tips 218 into the sidewall of the fluid tubing as the compression collar 204 advances onto the clamp fitting 202 by threading the two together to form the compression connector 200.

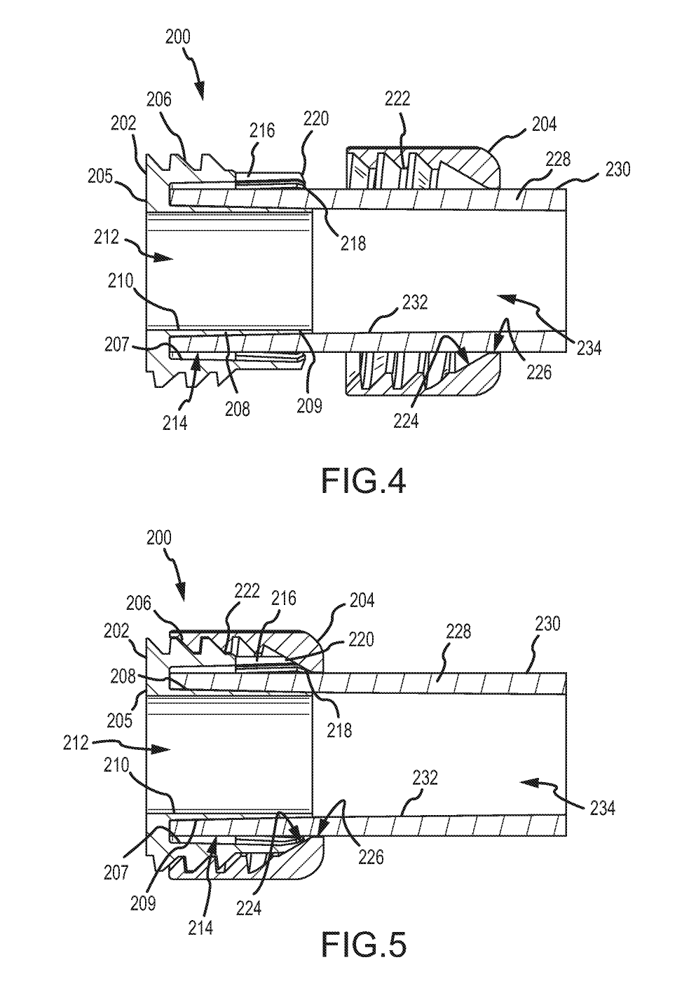

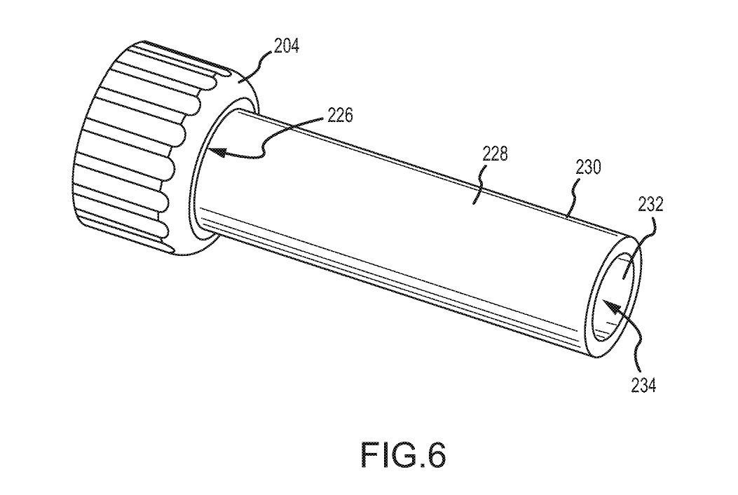

The connection of the compression collar 200 with a length of flexible fluid tubing 228, e.g., a length of silicon tubing, is depicted in stages in FIGS. 3-6. In FIG. 3, the fluid tubing is initially advanced through the collar rim 226 of the compression collar 204 such that the collar rim 226 snugly engages the OD 230 of the fluid tubing 228 as the fluid tubing 228 advances through the compression collar 204. In FIG. 4, the fluid tubing 228 is shown advanced over the sleeve 208 of the clamp fitting such that the distal end of the fluid tubing 228 is fully within the annular channel 214 in contact with the end wall 205, which acts as a positive stop. The tapered OD of the sleeve 208 allows the fluid tubing 228 to slowly stretch as it advances over the sleeve 208 and create a fluid-tight, friction fit between the OD 209 of the sleeve 208 and the ID 232 of the fluid tubing 228. Note that the ID 210 of the sleeve 208 is only slightly smaller than the ID 232 of the fluid tubing 228, thereby minimizing turbidity of the fluid flow as it transitions from the lumen 234 of the fluid tubing into the lumen 212 of the clamp fitting 202 defined by the sleeve 208. Also note that the OD 209 of the sleeve 208 is maintains a completely flush fit with the ID 232 of the fluid tubing 228, i.e., there is no void area 110 as in the prior art shown in FIG. 1B between the sleeve 208 and the fluid tubing 228.

FIG. 5 depicts the compression collar 204 partially threaded onto the clamp fitting 202 to form the coupled compression connector 200. As shown in FIG. 5, the bearing edges 220 of each of the grip fingers 216 interface with the conical surface 224 of the compression collar 204. As the compression collar 224 is threaded onto the clamp fitting 202, the conical surface 224 drives the bearing edges 220 and thus the claw tips 218 radially inward to engage the sidewall 230 of the fluid tubing 228. The grip fingers 216 are flexed slightly inward from the point of cantilever with the edge of the sidewall 207. The claw tips 218 thereby impress against and grip the sidewall 230 of the fluid tubing 228 preventing removal of the fluid tubing from the compression connector 200. The claw tips 218 and the sizing and interaction of the bearing edges 220 and the conical surface are designed such that the claw tips 218 do not penetrate the fluid tubing 228 and thereby compromise the integrity of the fluid tubing 228. Due to the mechanical advantage of the threads to drive the grip fingers 216 into the tubing 228, a higher axial retention of the tubing 228 than a typical barbed fitting with the same tubing can be achieved, especially with softer silicone tubing. With this configuration of the compression connector thus disclosed, the problem of fluid collection between the fluid tubing and a connector is avoided.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A compression connector for flexible fluid tubing comprising
a clamp fitting having
an inner sleeve defining a lumen and having an outer sealing surface configured to fit within an end of a flexible fluid tubing;
a plurality of grip fingers positioned circumferentially about and apart from the inner sleeve and configured to deflect radially inward toward the outer sealing surface of the inner sleeve, and
a male thread defined within a base of the clamp fitting; and
a compression collar that securely fastens to the clamp fitting, the compression collar having
an internal female thread for mating with the male thread of the clamp fitting; and
an inner surface for mating with the plurality of grip fingers and deflecting the plurality of grip fingers to engage and retain the flexible fluid tubing placed on the outer sealing surface.

2. The compression connector of claim 1, wherein an annular channel is defined within the clamp fitting between the inner sleeve and a wall of the base defining the male thread.

3. The compression connector of claim 2, wherein a width of the annular channel is sized to receive an end of the flexible fluid tubing.

4. The compression connector of claim 1, wherein the plurality of grip fingers extends from a surface of the wall of the base substantially parallel to a longitudinal axis of the clamp fitting.

5. The compression connector of claim 1, wherein the outer sealing surface of the inner sleeve tapers radially inward.

6. The compression connector of claim 5, wherein a diameter of the lumen defined by the inner sleeve is constant along a length of the inner sleeve.

7. The compression connector of claim 4, wherein a diameter of the lumen defined by the inner sleeve tapers along a length of the inner sleeve.

8. The compression connector of claim 1, wherein a diameter of the lumen defined by the inner sleeve tapers along a length of the inner sleeve.

9. The compression connector of claim 1, wherein the compression collar defines a lumen sized to receive the flexible fluid tubing therethrough.

10. The compression connector of claim 1, wherein each of the plurality of grip fingers defines a claw tip that, at least in part, is directed radially inward toward the inner sleeve.

11. The compression connector of claim 10, wherein a distal end of each of the plurality of grip fingers defines a tapered end surface adjacent the claw tip.

12. The compression connector of claim 11, wherein the inner surface of the compression collar defines a complimentary angle to an angle of the tapered end surface of the plurality of grip fingers when the grip fingers are fully deflected and engaged with the flexible fluid tubing.

13. The compression connector of claim 12, wherein the inner surface of the compression collar is conical in form.

14. The compression connector of claim 1, wherein the inner surface of the compression collar is conical in form.

15. The compression connector of claim 2, wherein
the outer sealing surface of the inner sleeve tapers radially inward as it extends away from the base; and
the wall of the base defining the annular channel angles radially outward as the wall extends adjacent the inner sleeve, whereby
a bottom well of the annular channel is narrower than an upper portion of the annular channel.

16. The compression connector of claim 1, wherein each of the plurality of grip fingers is spaced equidistantly apart from adjacent ones of the plurality of grip fingers.

17. The compression connector of claim 1, wherein the clamp fitting further comprises a reciprocal fitting extending from the base for connecting with another fluid tubing.

18. The compression connector of claim 1, wherein the outer sealing surface is cylindrical or substantially cylindrical and is configured to maintain a flush contact with flexible fluid tubing over an entirety of the outer sealing surface.

19. The compression connector of claim 1, wherein an inner diameter of the inner sleeve defining the lumen is configured to be only slightly smaller than an inner diameter of the flexible fluid tubing.
